(19) United States
(12) Patent Application Publication
(10) Pub. No.: US 2009/0314457 A1
(43) Pub. Date: Dec. 24, 2009

(54) Device and Method for Producing a Metal Strip by Continuous Casting

(76) Inventors: Jürgen Seidel, Kreuztal (DE); Peter Sudau, Hilchenbach (DE); Jürgen Merz, Kreuztal (DE); Matthias Kipping, Herdorf (DE)

Correspondence Address: FRIEDRICH KUEFFNER, 317 MADISON AVENUE, SUITE 910, NEW YORK, NY, 10017, US

(21) Appl. No.: 12/227,558

(22) PCT Filed: May 23, 2007
(86) PCT No.: PCT/EP2007/004579

§ 371 Date: Jan. 26, 2009

(30) Foreign Application Priority Data
May 26, 2006 (DE) 10 2006 024 586.5
May 14, 2007 (DE) 10 2007 022 929.3

(51) Int. Cl. B22D 11/126; B22D 11/12; B23C 5/28; B22D 11/124

(52) U.S. Cl. 164/417; 408/61; 409/136

(57) ABSTRACT

The invention relates to a device for producing a metal strip (1) by continuous casting, using a casting machine (2) in which a slab (3) is cast. At least one milling machine (4) is arranged in the direction of transport (F) of the slab (3) behind the casting machine (2) in which at least one surface of the slab (3), preferably two surfaces which are opposite to each other, can be milled. According to the invention, in order to optimise the service life of the milling cutter of the milling machine, means (5) for cooling the milling cutter (6) are provided on or in the milling machine (4). The invention also relates to a method for producing a metal strip.

The invention concerns a device for producing a metal strip by continuous casting with a casting machine in which a slab is cast, where at least one milling machine is installed downstream of the casting machine in the direction of conveyance of the slab, at least one surface of which and preferably two opposite surfaces of which can be milled down in the one or more milling machines, and where means for cooling a milling cutter are provided in or on the milling machine.

In the continuous casting of slabs in a continuous casting installation, surface defects can develop, for example, oscillation marks, casting flux defects, or longitudinal and transverse surface cracks. These occur in both conventional and thin-slab casting machines. Therefore, the conventional slabs are subjected to flame descaling in some cases, depending on the intended use of the finished strip. Many slabs are subjected to flame descaling as a general rule at the customer's request. In this connection, the requirements on surface quality have been continuously increasing in thin-slab installations.

Flame descaling, grinding, and milling are available methods of surface treatment.

Flame descaling has the disadvantage that the material that has been flashed off cannot be melted down again without processing due to the high oxygen content. In the case of grinding, slivers of metal become mixed with the grinding wheel dust, so that the abraded material must be disposed of. Both methods are difficult to adapt to the given conveyance speed.

Therefore, surface treatment by milling must be considered. The hot millings are collected during the milling operation. They can then be briquetted and melted down again without any problems and thus returned to the production process. Furthermore, the miller speed can be easily adjusted to the conveyance speed (casting speed, feeding speed into the finishing train). The device of the aforesaid type that constitutes the object of the invention thus involves the use of milling.

A device of the aforementioned type is disclosed by EP 0 881 017 A, which provides that the milling cutters are cooled by water to enable them to withstand the high temperatures of the strand that is to be milled. However, the cited document fails to provide more comprehensive directions or specific information regarding the design of the milling cutter cooling system.

Other solutions are described in US 2003/223831, U.S. Pat. No. 5,073,694 A, and U.S. Pat. No. 3,702,629 A.

Another device of a similar type with a milling machine arranged downstream of a continuous casting installation is already known from CH 584 085 and DE 199 50 886 A1.

Another similar device is also disclosed by DE 71 11 221 U1. This document discloses the processing of aluminum strip with utilization of the casting heat, in which the machine is connected with the casting installation.

In-line removal of material from the surface of a thin slab (flame descaling, milling) shortly before a rolling train on the upper side and underside or on only one side has also already been proposed. EP 1 093 866 A2 is cited in this connection.

DE 197 17 200 A1 discloses another embodiment of a surface milling machine. This document describes, among other things, the adjustability of the milling contour of the milling device, which is installed downstream of the continuous casting installation or upstream of a rolling train.

Another embodiment and arrangement of an in-line milling machine in a conventional hot strip mill for treating a near-net strip are proposed by EP 0 790 093 B1, EP 1 213 076 B1, and EP 1 213 077 B1.

In the surface treatment of thin slabs in a so-called CSP plant, about 0.1-3.5 mm should be removed from the surface on one or both sides of the hot slab in the processing line (“in line”), depending on the surface defects that are detected. A thin slab that is as thick as possible is advisable (H=60-120 mm) so as not to diminish the output too much.

The surface treatment and the equipment needed to carry it out are not limited to thin slabs but rather can also be used in line downstream of a conventional thick-slab casting installation as well as for slabs cast with a thickness greater than 120 mm up to 300 mm.

The in-line milling machine is not usually used for all products of a rolling program but rather only for those that have relatively high surface requirements. This is advantageous from the standpoint of output, reduces milling machine wear, and therefore is useful.

It has been found that the service life of the milling cutter or cutters with which the surface of the slab is milled in the milling machine, i.e., the length of time that the milling cutter or cutters can be used, is not always satisfactory. This is related to the relatively high material stress to which the material of the cutter edge is subjected during the machining of the hot slab.

Therefore, the objective of the present invention is to improve a device for producing a metal strip by continuous casting with the use of a casting machine in such a way that the aforementioned disadvantages are avoided. In other words, the goal is to create a device with which the milling tool or tools are protected, even when used for prolonged periods of time in the machining of hot slabs, so that longer service lives can be realized.

The solution to this problem by the invention is characterized by the fact that a collecting device for cooling medium is arranged near the milling cutter. The collecting device has a cover that covers the milling cutter on one side. Various embodiments are provided for this purpose:

The means for cooling the milling cutter can be realized as nozzles, with which a cooling medium can be applied to the area of the cutting surfaces of the milling cutter, preferably over the entire width. In this regard, the nozzles can be arranged in such a way that they apply the cooling medium to the milling cutter at a point some distance from the slab. This makes it possible to prevent excessive cooling of the slab. The cooling medium can be collected in a collecting device.

Alternatively or additionally, the milling cutter can have at least one internal cooling medium supply bore that leads to the region of the cutting surfaces. In this regard, the milling cutter can have a concentric supply bore, from which at least one additional supply bore leads to the region of the cutting surfaces.

In order to cool the slab as little as possible by cooling medium, since cooling of the slab is often a disadvantage, a collecting device for cooling medium can be arranged near the milling cutter. This device can have a collecting trough for cooling medium. As explained above, the collecting device has a cover that covers the milling cutter on one side. In this regard, the cover can have a semicircular design as viewed in the direction of the axis of rotation of the milling cutter. Furthermore, in one modification, it is provided that a collecting trough is located in the upstream and/or downstream end region of the cover with respect to the direction of conveyance.

Another alternative of the idea of the invention provides that the means for cooling the milling cutter are designed as a ventilator or a blower.

To be able to use liquid cooling medium but prevent the slab from cooling, another alternative or additional embodiment of the invention provides that the means for cooling the milling cutter are designed as bores, by which a cooling medium is conveyed through the inside of the milling cutter.

Means for conveying the liquid cooling medium are preferably present in a closed system. In this regard, it is especially preferred that the cooling medium be integrated in the circulation of the cooling system of the whole plant.

The cooling medium can be water, an oil-water emulsion, air, spray mist, or water vapor.

Means for adjusting the temperature distribution over the thickness of the slab and/or for cleaning the surface of the slab can be installed immediately upstream of the milling machine in the direction of conveyance. These means can be nozzles for applying a fluid to the slab.

One milling cutter each is usually installed for treating the upper side and the underside of the slab. Each milling cutter can cooperate with a support roll arranged on the other side of the slab. A rolling train is usually installed downstream of the milling machine in the direction of conveyance.

In accordance with a modification, both means for cooling the milling cutter from the outside and means for cooling the milling cutter from the inside are provided.

Preferably, it is provided that the means for cooling the milling cutter are designed for undercooling the surface of the slab shortly before the milling process.

The means for cooling the milling cutter can be designed in such a way that different amounts of coolant can be applied to the upper side and the underside of the slab.

One milling cutter each can be installed for machining the upper side and the underside of the slab.

A descaling sprayer can be installed between the milling machine and a downstream rolling stand. In this regard, in a preferred embodiment, the descaling sprayer is configured as a single row of sprayers.

The method for producing a metal strip by continuous casting with a device of the type explained above is characterized by the fact that the slab temperature is measured on the upper side and/or underside of the slab upstream and/or downstream of the milling machine, where the amount of coolant with which the slab is cooled is determined with a process model operated in a machine control unit as a function of the measured temperatures.

In this regard, in accordance with a refinement of the invention, the cooling of the slab can be carried out on the upper side and the underside of the slab.

An alternative embodiment of this method provides that the slab is cooled, and the amount of coolant for cooling the slab is determined with a process model operated in a machine control unit, where the process model determines the amount of coolant as a function of the volume of material milled from the slab.

The determination of the amount of coolant can be made by additionally considering the slab conveyance speed and/or the temperature of the surface of the slab and/or the type of material of the slab.

The proposed solution makes it possible to realize a significant reduction of the thermal load on the cutting tool. Hence, it is possible to realize significantly longer service lives than in conventional milling machines used for the specified application. Even when used for prolonged periods of time, the milling tool is protected from the high slab surface temperature in the hot rolling process, and this produces the specified advantage. Long service lives of this type were not previously attainable, because only the usual lubricating emulsion or lubricating oil was used during milling.

Specific embodiments of the invention are illustrated in the drawings.

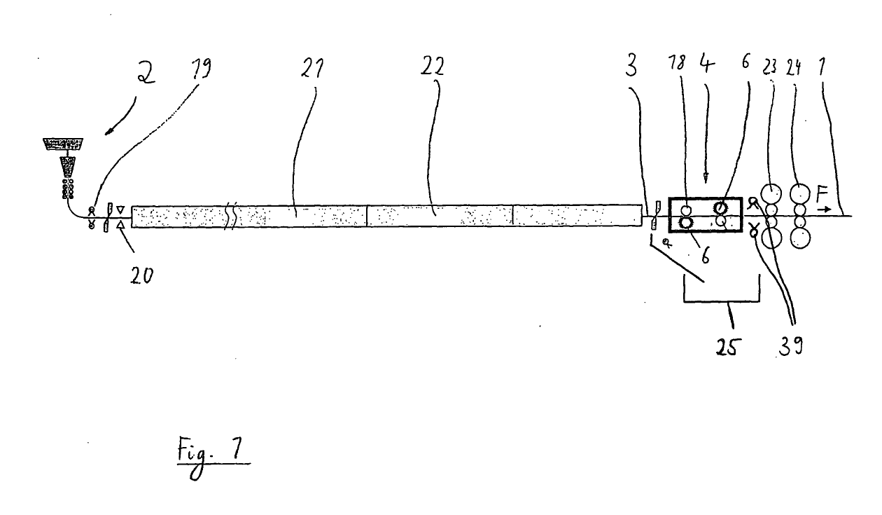

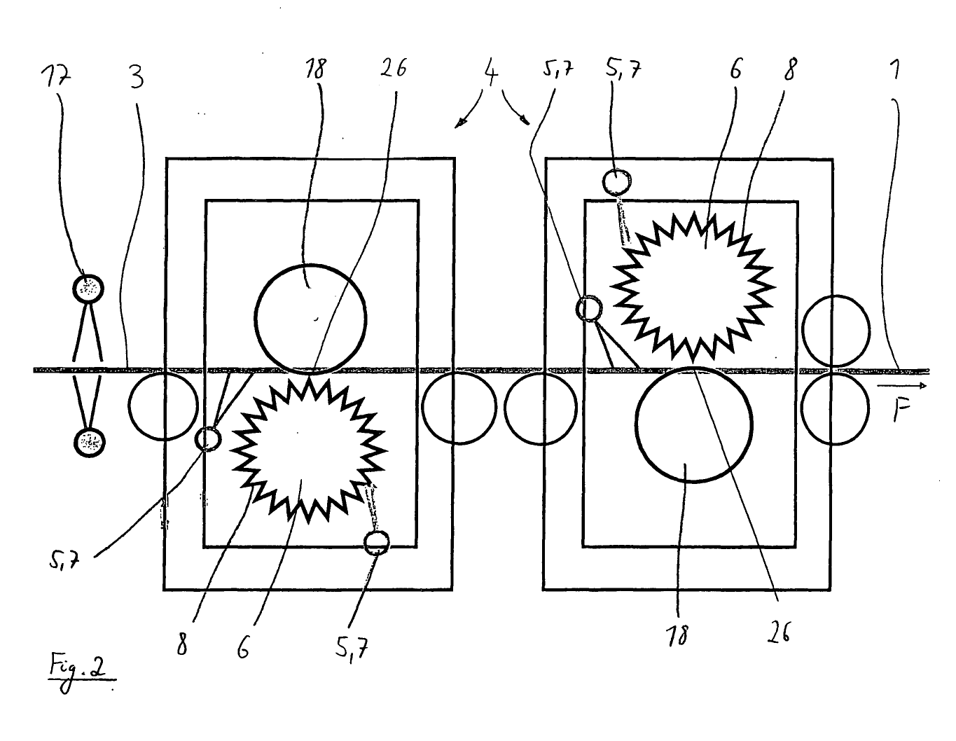

FIG. 1 shows a schematic side view of a device for producing a metal strip by continuous casting, in which a milling machine is used.

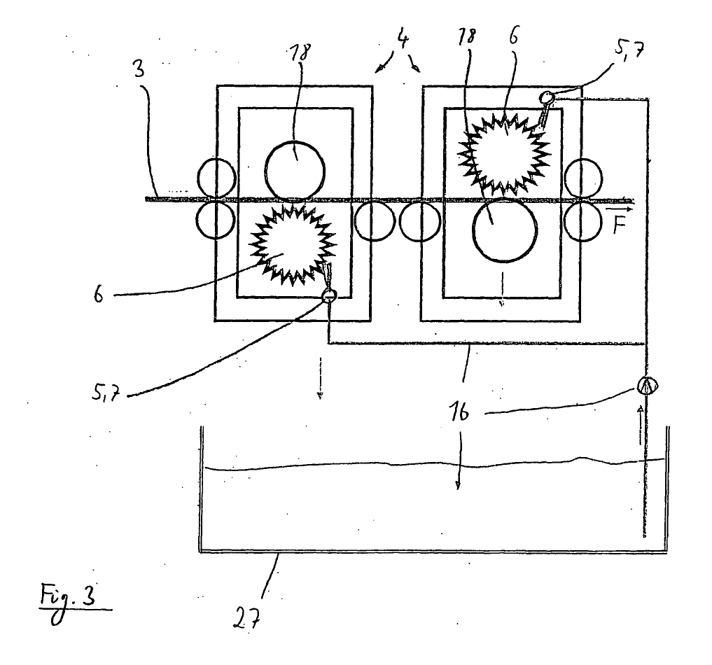

FIG. 2 is an enlarged section of FIG. 1 illustrating the milling machine.

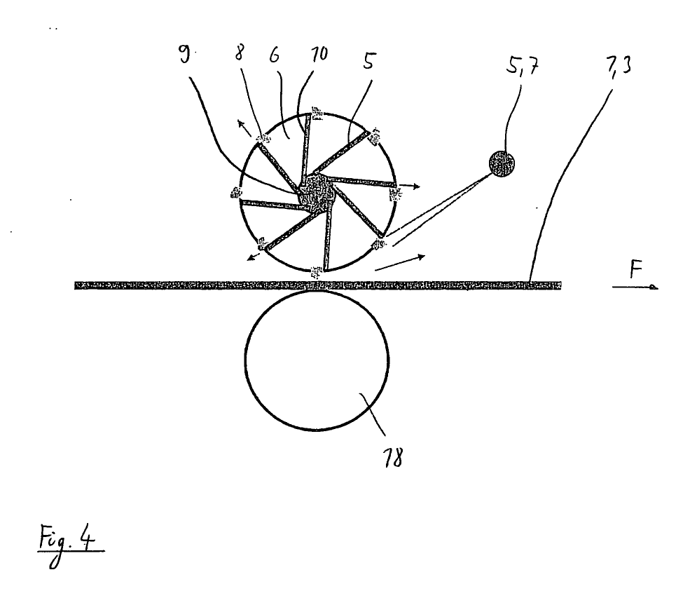

FIG. 3 shows the arrangement according to FIG. 2 with a device for conveying the cooling medium in a closed system.

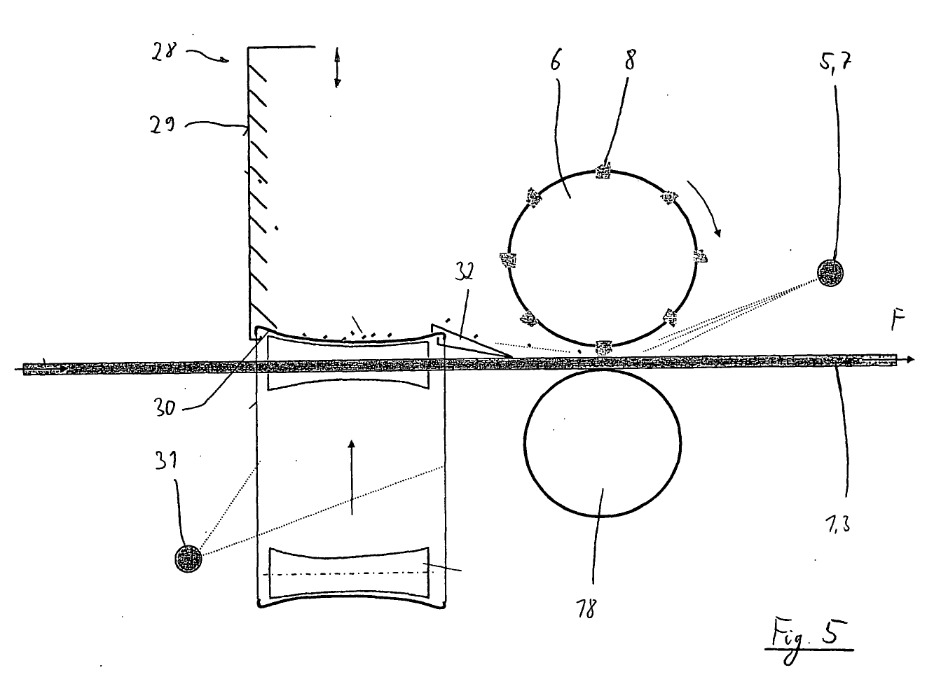

FIG. 4 shows a side view of a milling cutter together with a support roll in an alternative embodiment of the invention.

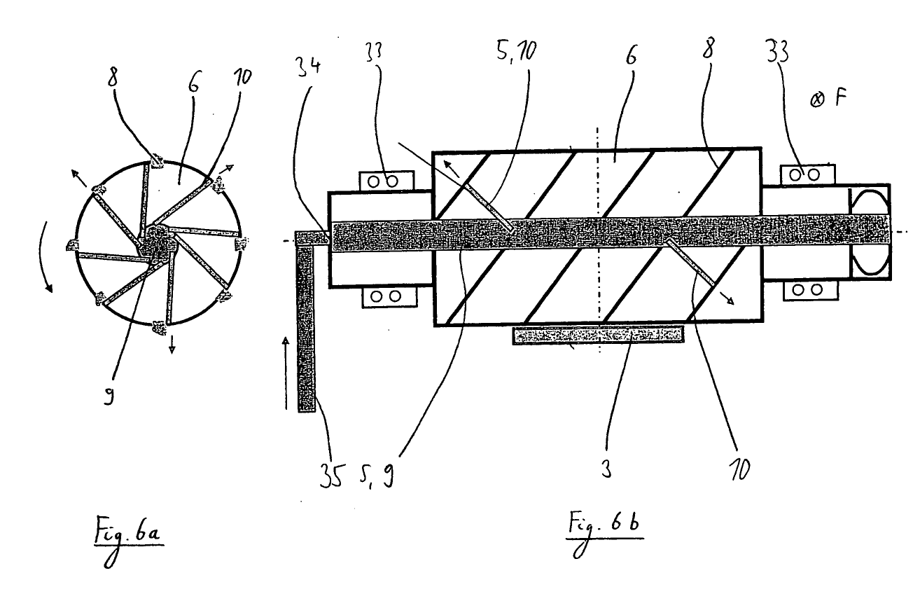

FIG. 5 shows a side view of a milling cutter together with a support roll and a cuttings transport device in another alternative embodiment of the invention.

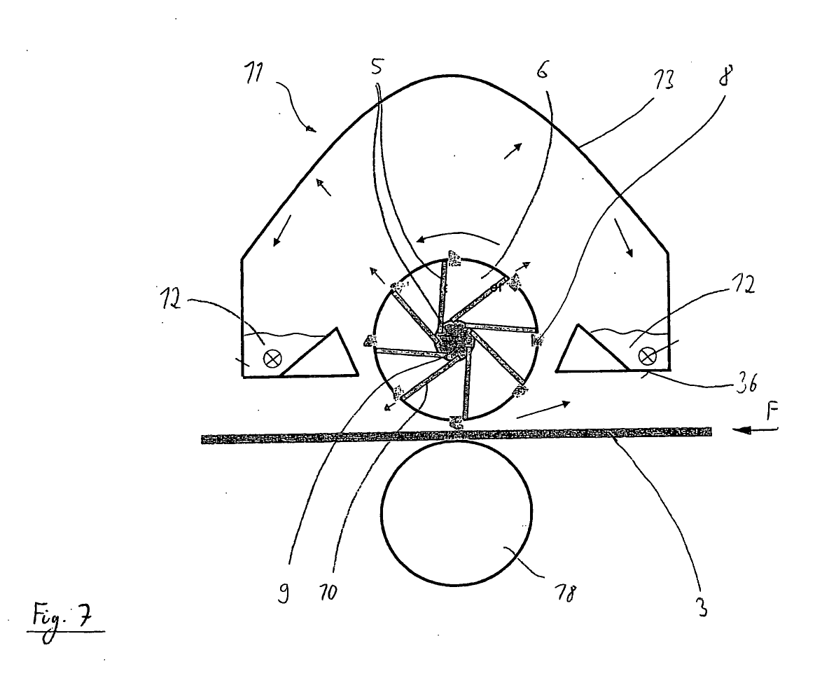

FIG. 6a shows a side view and

FIG. 6b shows a front view of a transverse section of a cooled milling cutter in another embodiment of the invention.

FIG. 7 shows a side view of a milling cutter for the upper side of the slab together with a support roll with a collecting device for cooling medium.

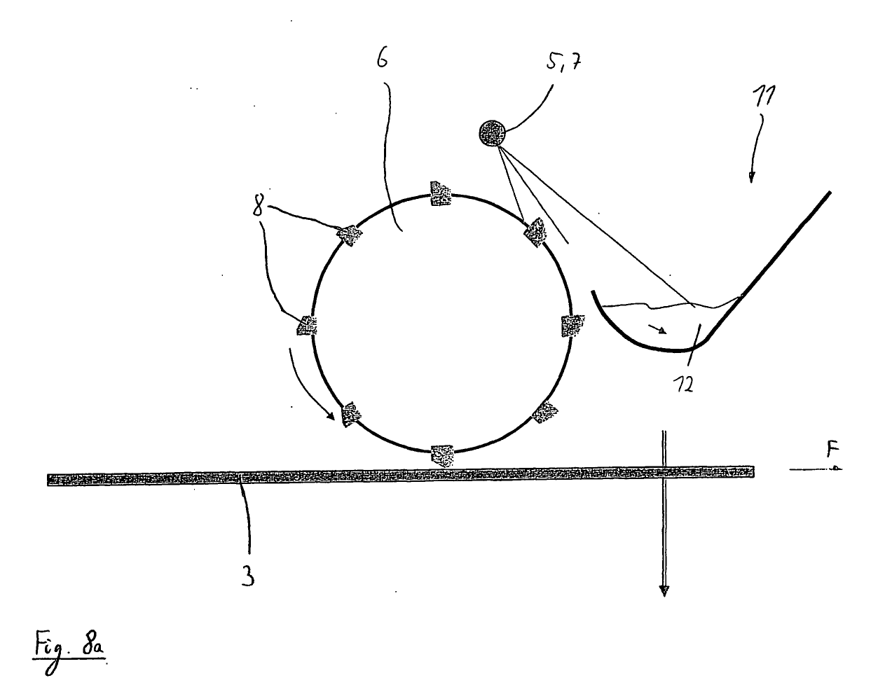

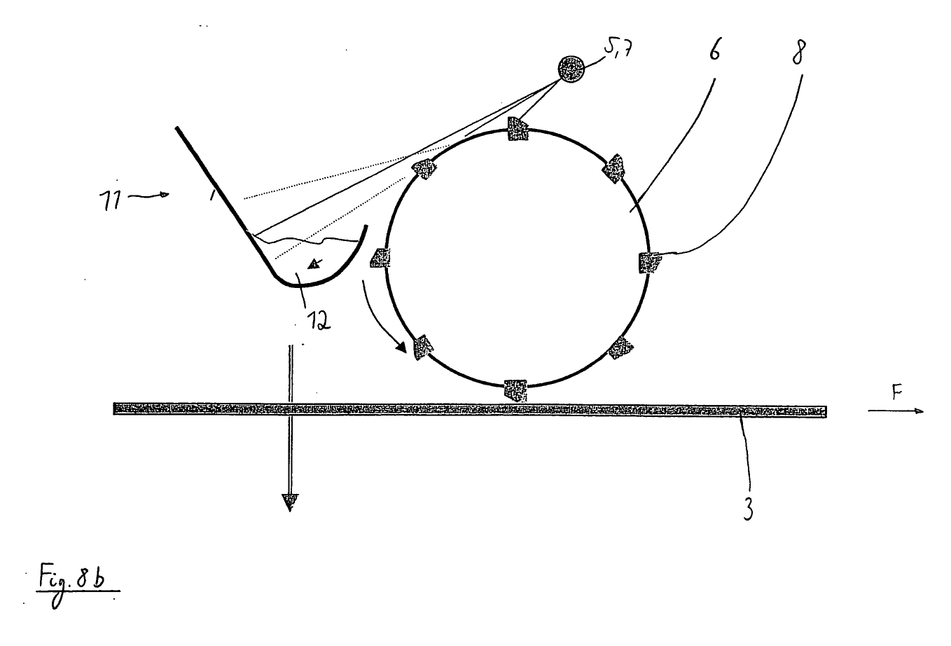

FIG. 8a shows a side view of a milling cutter with a collecting device for cooling medium in an alternative embodiment to that of FIG. 7.

FIG. 8b shows a variant of FIG. 8a.

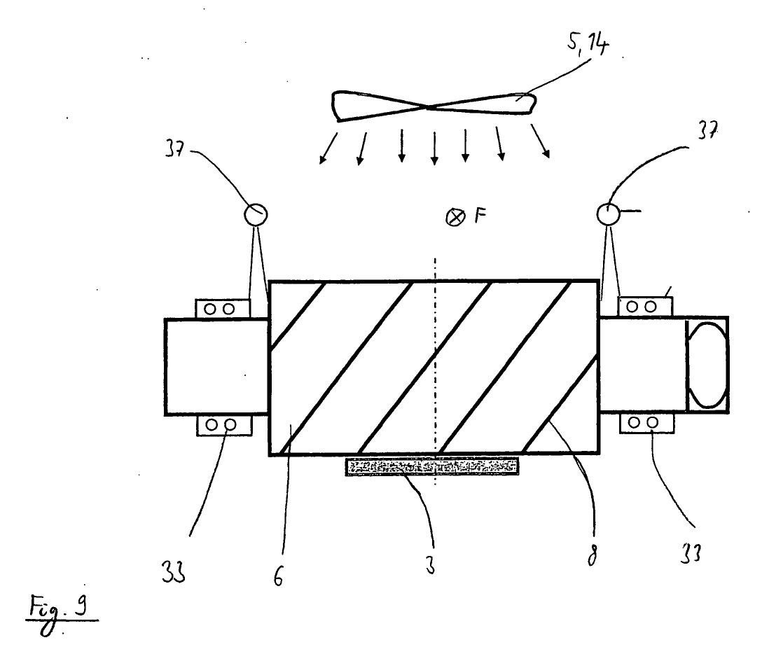

FIG. 9 shows a front view of a milling cutter with an air cooling system and water cooling of the bearings.

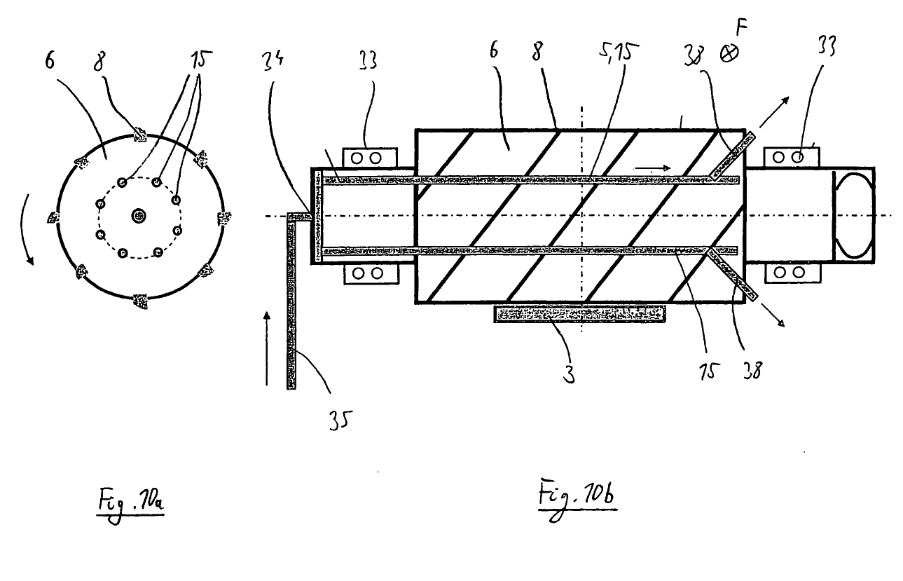

FIG. 10a shows a side view and

FIG. 10b shows a front view of a transverse section of a cooled milling cutter in another embodiment of the invention.

FIG. 1 shows a device for producing a metal strip 1 by continuous casting. The metal strip 1 or the corresponding slab 3 is continuously cast in a well-known way in a casting machine 2. The slab 3 is preferably a thin slab. Immediately downstream of the casting machine 2, the slab 3 is subjected to a slab cleaning operation in a cleaning installation 19. A surface inspection is then performed by means of a surface measuring device 20. The slab 3 then enters a furnace 21, so that it can be held at a desired process temperature. The furnace 21 is followed by a transverse conveyor.

Downstream of the furnace 21 and the transverse conveyor 22, the slab 3 enters a milling machine 4. In the present case, two milling cutters 6 are installed in the milling machine 4 some distance apart in the direction of conveyance F for milling the lower surface and the upper surface, respectively, of the slab 3. The corresponding opposite surfaces of the slab 3, i.e., the upper side and the underside of the slab, respectively, are supported by support rolls 18.

A descaling system 39 is located downstream of the milling machine 4 and in the present case comprises a single-row descaling sprayer above the slab and another below the slab. It is followed by a rolling train, which in the present case comprises the rolling stands 23 and 24.

A collecting tank 25, in which material that has been removed by milling is collected, is located under the milling machine 4.

As can be seen in FIG. 2, the milling machine 4 is provided with means 5 for cooling the milling cutters 6. In the present case, these means 5 are realized as spray nozzles 7, which can deliver a suitable cooling medium (liquid or gaseous) to the milling cutters 6 over the width of the slab 3. In this way, the milling cutters 6 and especially their cutting surfaces 8 can be directly or indirectly cooled, as is indicated in FIG. 2 in only a highly schematic way.

It can be seen that spray nozzles 7 can be arranged in such a way that the cutting surfaces 8 of the milling cutters 6 can be directly sprayed. However, as will be seen later, it can also be provided that cooling medium is delivered directly onto the slab 3, so that in this respect the milling cutters 6 are cooled indirectly. Both possibilities are illustrated in FIG. 2. In the latter case, the surface of the strip is thus cooled immediately upstream of the milling cutter 6.

As is indicated by position 26 in FIG. 2, the support roll 18 is arranged somewhat below or above the pass line to produce contact pressure against the support roll.

In addition, the solution illustrated in FIG. 2 provides that means 17 for cleaning the surface of the slab are installed immediately before the milling machine 4. This also makes it possible to cool the slab, which protects the milling cutters 6 and also causes the slab 3 to be fed to the milling cutters 6 in a precleaned condition, which also helps protect the cutters. The means 17, which are designed as spray nozzles, make it possible to adjust the surface temperature from the upper side to the underside of the slab. The amount of water delivered by the nozzles 17 is adjusted as a function of the measured temperature distribution before and/or after the milling machine 4.

FIG. 3 shows that means 16 can be provided for conveying the cooling medium in a closed system. These means 16 include a collecting tank 27 for preparing the cooling medium, which is preferably an emulsion or dispersion. Fresh cooling medium components (oil or water, depending on the desired mixing ratio of the cooling medium) can be added as needed.

FIG. 4 shows that the cutting surfaces 8 of the milling cutter 6 can also be sprayed in the direction opposite the direction of conveyance F from the downstream side of the milling cutter 6. Moreover, it also shows a solution in which a type of cooling of the milling cutter 6 is provided, which will be described in greater detail later in connection with FIG. 6. The cooling of the cutting edges can be realized here in the form of a simple bore. Alternatively, a spray nozzle can be provided at the exit point, which fans out the jet of cooling medium (water jet) and directs it towards the cutting surface 8 of the milling cutter 6. Instead of cutting edge water cooling, it is also possible to provide cutting edge lubrication. A combination of lubrication of the cutting edges of the milling cutter (milling cutter lubrication) from the inside and milling cutter cooling from the outside is also possible.

In the solution according to FIG. 5, it is also provided that spraying (with liquid, especially water) or blowing (with gas, especially compressed air) of the cutting surfaces 8 of the milling cutter 6 occurs in the direction opposite the direction of conveyance F from the downstream side of the milling cutter 6. The direction of rotation of the milling cutter 6 is indicated by the arrow. A cuttings transport unit 28, which can be raised or swiveled, is provided upstream of the milling cutter 6 with respect to the direction of conveyance F and can be moved in the direction of the double arrow. A deflecting plate 29 with ribs is provided in the forward region. A heat-resistant conveyor belt 30 arranged at the level of the slab 3 carries away the cuttings from the milling process. The conveyor belt 30 can be cooled with a nozzle 31, which delivers cooling medium onto the conveyor belt 30. A stripper 32 guides the cuttings onto the conveyor belt 30. The cuttings still lying on the slab 3 between the stripper 32 and the milling cutter 6 are blown or carried onto the conveyor belt by spraying with the aforementioned medium.

In the solution according to FIGS. 6a and 6b, the means 5 for cooling the milling cutter 6 are designed as follows: The milling cutter 6 is supported at each end by a bearing 33. In an axial end region of the milling cutter 6, a rotating joint 34 is arranged, with which cooling medium, for example, in the form of water, is supplied to the milling cutter 6 through a line 35 in the direction indicated by the arrow. The milling cutter 6 has a centric supply bore 9, from which additional supply bores 10 extend at an angle to the radial direction. These supply bores 10 terminate in the vicinity of the cutting surfaces 8, so that cooling medium supplied through the line 35 reaches the cutting surfaces 8. Accordingly, an integrated coolant bore is provided for cooling the cutting edges. Cooling medium can be used under both high pressure and low pressure. This makes it possible to reduce thermal stresses in the cutting surfaces 8.

The cooling medium basically cools not only the milling cutter 6, as desired, but also the slab 3, which in some cases is not desired. To realize optimization in this respect, the embodiment of the invention shown in FIG. 7 provides a collecting device 11, which collects the cooling medium after it has cooled the milling cutter 6, so that it does not cool the slab 3 excessively.

In the embodiment illustrated in FIG. 7, the collecting device 11 is designed in such a way that it has a curved cover 13 that covers the milling cutter 6 over a peripheral extent of about 180°. To prevent as much as possible the cooling medium from getting onto the slab after the cooling of the milling cutter 6, collecting troughs 12 are formed from the sheet metal of the cover 13 upstream and downstream of the milling cutter 6 and constitute a collection volume for the cooling medium. The collecting troughs 12 can be formed as channels with a gradient to allow the cooling medium to flow off. The region of each collecting trough 12 that faces the slab 3 can form a deflecting plate 36 for cuttings. Otherwise, cuttings that undesirably enter the collecting trough 12 can be flushed out of the trough.

FIGS. 8a and 8b show a solution that is simpler but in many cases adequate. In this case, a simplified collecting device 11 is provided, which consists of a piece of sheet metal that is bent in such a way that a collecting trough 12 is formed. In the illustrated embodiment, it is provided that the means 5 for cooling are again realized as nozzles 7, which direct a jet of cooling medium over the whole width of the milling cutter 6. Depending on the arrangement and orientation of the nozzle 7 and of the jet of cooling medium, the collecting device 12 can be located downstream (FIG. 8a) or upstream (FIG. 8b) of the milling cutter 6 with respect to the direction of conveyance F. The direction of rotation of the milling cutter 6 is again indicated by an arrow. The cooling medium collected by the collecting device 11 can run off to the side next to the slab 3 into a sintered channel (see vertical arrow).

FIG. 9 shows that, in cases in which the cooling of the milling cutter 6 does not need to be extremely intense, air cooling is also possible. In the present case, a blower 14 is installed above the milling cutter 6. It blows air at the milling cutter 6 from above and thus cools it. As in the other embodiments as well, nozzles 37 can be arranged on the sides to cool the bearings 33.

FIGS. 10a and 10b show another alternative embodiment of the cooling of the milling cutter 6. This embodiment again takes into account the fact that it can be undesirable for the slab 3 to be cooled to an excessive degree by cooling medium. Therefore, this solution provides that a number of bores 15 run in the axial direction inside the milling cutter 6. Cooling medium is conveyed through these bores to cool the milling cutter 6. As in the embodiment illustrated in FIG. 6, a rotating joint 34 is provided, by which cooling medium is conveyed by a line 35 into the bores 15. In this case, however, the cooling medium does not emerge until it reaches the opposite axial end of the milling cutter 6 and runs off into a sintered channel, so that the slab 3 is not cooled by the cooling medium. As the illustrated embodiment shows, the bores 15 are formed as blind holes; the cooling medium flows off through discharge bores 38 that branch off the bores 15 at an angle.

The ideas of the invention in this respect can be summarized in the following way:

During prolonged use, the milling cutter 6 is subject to high thermal stress during the hot rolling process. Cooling is advantageous, so that the plain milling cutter, the bearings, etc., do not become too hot. Accordingly, in one embodiment of the invention, in order to protect the milling tool 6 from the high surface temperature of the slab during prolonged in-line processing, the surface of the strip is cooled shortly before the engagement of the milling cutters, which results in a reduction of the heat flux into the cutting edges of the milling cutters.

In addition, the plain milling cutter is shielded from the hot surface. In the case of IF steel or ULC steel, a target temperature at the surface that corresponds to the transformation temperature is aimed at for the short milling operation. It is expected that the material will temporarily experience thermal softening and that this will lead to lower deformation stress and thus lower cutting edge stress.

The rotating cutting surfaces 8 of the milling tool 6 are sprayed with lubricant (oil mist, oil-water mixture, etc.) in order to reduce the cutting force and thus increase the service life of the milling tool. However, in contrast to the prior art, the lubricant is not applied to the hot strip (as is customary in cold milling) but rather is sprayed onto the cutting edge, to which the oil adheres and later acts during the cutting process.

To avoid milling off of the hard layer of scale and thus to increase the service life of the cutting edges of the milling cutter, a (low-pressure) descaling of the surface (see reference number 17 in FIG. 2) upstream of the milling machine 4 is conceivable.

The amounts of water delivered by the cooling and cleaning spray bars can be separately adjusted above and below in order to combat or prevent transverse camber of the slab.

Suction devices for cuttings, deflecting devices for cuttings, or areas for flushing out cuttings (collecting hoppers, deflecting plates, suction pipes, lateral sprayers, strippers on the strip, etc.) are provided upstream and downstream of a given milling cutter 6 to make it possible for the milling cutter 6 optionally to carry out downcut milling and upcut milling.

To allow the advantageous option of avoiding cooling of the slab 3 during the cooling of the milling cutter 6, the plain milling cutter 6 can be cooled internally. The cooling water is preferably supplied from one end through a rotating joint; the outlet at the opposite end is designed open, so that the water can drain freely at the end into a sintered channel.

In the case of external cooling of the milling cutter, the cooling water falls onto the slab, especially on the upper side of the slab. To avoid an undesired cooling effect on the slab, the water can be collected in a channel. In this case, cooling water is sprayed tangentially onto the cutting edges of the milling cutter and collected in the channel arranged on the downstream side, so that it can run off laterally next to the strip into the sintered channel.

In the case of relatively low thermal loads, air cooling is also possible for external cooling of the plain milling cutter 6. This type of cooling can also be combined with water cooling of the bearing of the plain milling cutter.

The amount of cooling medium for the milling cutter 6 is controlled as a function of the milling removal or the volume of milled cuttings.

Some especially advantageous design features should be additionally noted:

As FIG. 4 shows, lubrication of the cutting edges with emulsion by means of the supply bores 10 is applied to the cutting surface 8 of the milling cutter 6, and at the same time, the milling cutter 6 is externally cooled by means of the nozzles 7.

In addition, as shown in FIG. 5, it can be provided that the nozzles 7 help transport the cuttings from the surface of the slab via the stripper 32 to the conveyor belt 30 and simultaneously cool the surface of the slab and the milling cutter 6.

### LIST OF REFERENCE SYMBOLS

1 metal strip
2 casting machine
3 slab
4 milling machine
5 means for cooling the milling cutter
6 milling cutter
7 nozzle
8 cutting surface
9 supply bore
10 supply bore
11 collecting device
12 collecting trough
13 cover
14 ventilator/blower
15 bore
16 means for conveying the cooling medium in the closed system
17 means for cleaning the slab surface and controlling the temperature distribution over the thickness of the slab
18 support roll
19 cleaning installation
20 surface measuring device
21 furnace
22 transverse conveyor
23 rolling stand
24 rolling stand
25 collecting tank
26 position
27 collecting tank
28 cuttings transport unit
29 deflecting plate
30 conveyor belt
31 nozzle
32 stripper
33 bearing
34 rotating joint
35 line
36 deflecting plate
37 nozzle
38 discharge bore
39 descaling sprayer (single-row)
F direction of conveyance

1. A device for producing a metal strip (1) by continuous casting with a casting machine (2) in which a slab (3) is cast, where at least one milling machine (4) is installed downstream of the casting machine (2) in the direction of conveyance (F) of the slab (3), at least one surface of which and preferably two opposite surfaces of which can be milled down in the one or more milling machines (4), and where means (5) for cooling a milling cutter (6) are provided in or on the milling machine (4), wherein a collecting device (11) for cooling medium is arranged near the milling cutter (6), where the collecting device (11) has a cover (13) that covers the milling cutter (6) on one side.

2. A device in accordance with claim 1, wherein the means (5) for cooling the milling cutter (6) are realized as nozzles (7), with which a cooling medium can be applied to the area of the cutting surfaces (8) of the milling cutter (6).

3. A device in accordance with claim 2, wherein the cooling means (5) extend over the entire width of the milling cutter (6).

4. A device in accordance with claim 2, wherein the nozzles (7) are arranged in such a way that they apply the cooling medium to the milling cutter (6) at a point some distance from the slab (3).

5. A device in accordance with claim 1, wherein the milling cutter (6) has at least one internal cooling medium supply bore (9, 10) that leads to the region of the cutting surfaces (8).

6. A device in accordance with claim 5, wherein the milling cutter (6) has several internal cooling medium supply bores (9, 10) that lead to the region of the cutting surfaces (8).

7. A device in accordance with claim 6, wherein the milling cutter (6) has a concentric supply bore (9), from which at least one additional supply bore (10) leads to the region of the cutting surfaces (8).

8. A device in accordance with claim 1, wherein the collecting device (11) has a collecting trough (12) for cooling medium.

9. A device in accordance with claim 1, wherein the cover (13) has a semicircular design as viewed in the direction of the axis of rotation of the milling cutter.

10. A device in accordance with claim 1, wherein a collecting trough (12) is located in the upstream and/or downstream end region of the cover (13) with respect to the direction of conveyance (F).

11. A device in accordance with claim 1, wherein means (16) for conveying the cooling medium are present in a closed system.

12. A device in accordance with claim 11, wherein the cooling medium is conveyed by integrating it in the circulation of the cooling system of the whole plant.

13. A device in accordance with claim 1, wherein the cooling medium is water.

14. A device in accordance with claim 1, wherein the cooling medium is an oil-water emulsion.

15. A device in accordance with claim 1, wherein the cooling medium is air.

16. A device in accordance with claim 1, wherein the cooling medium is a spray mist.

17. A device in accordance with claim 1, wherein the cooling medium is water vapor.

18. A device in accordance with claim 1, wherein both means for cooling the milling cutter (6) from the outside and means for cooling the milling cutter from the inside are provided.

19. A device in accordance with claim 1, wherein means (17) for adjusting the temperature distribution over the thickness of the slab are installed immediately upstream of the milling machine in the direction of conveyance (F) and at the same time are designed for cleaning the surface of the slab.

20. A device in accordance with claim 19, wherein the means (17) for adjusting the temperature distribution over the thickness of the slab are nozzles for applying a fluid to the slab (3).

21. A device in accordance with claim 1, wherein the means (5, 7) for cooling the milling cutter (6) are designed for cooling the surface of the slab shortly before the milling process.

22. A device in accordance with claim 1, wherein the means (5) for cooling the milling cutter (6) are designed in such a way that different amounts of coolant can be applied to the upper side and the underside of the slab (3).

23. A device in accordance with claim 1, wherein one milling cutter (6) each is installed for machining the upper side and the underside of the slab (3).

24. A device in accordance with claim 23, wherein each milling cutter (6) cooperates with a support roll (18) arranged on the other side of the slab (3).

25. A device in accordance with claim 1, wherein a descaling sprayer (29) is installed between the milling machine (4) and a downstream rolling stand (23, 24).

26. A device in accordance with claim 25, wherein the descaling sprayer (29) is configured as a single row of sprayers.
